(19) United States
(12) Patent Application Publication
(10) Pub. No.: US 2006/0084459 A1
(43) Pub. Date: Apr. 20, 2006

(54) Outer loop power control of user equipment in wireless communication

(76) Inventors: Vinh Phan, Oulu (FI); Ramin Baghaie, Espoo (FI); Karri Ranta-Aho, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/965,236

(22) Filed: Oct. 13, 2004

(51) Int. Cl. H04B 7/00; H04Q 7/20

(52) U.S. Cl. 455/522; 455/69

(57) ABSTRACT

A faster power control method especially of use in case of a UE device communicating with a SAP (e.g. a Node B) of a UTRAN via E-DCH, where instead of the SAP (e.g. a Node B) receiving from the serving RNC a new SIR target to use because of changing channel conditions in what is called outer loop power control, the SAP instead receives a BLER target or a target value for some other indicator of channel quality to use as a guide for determining, by itself, an appropriate SIR target.

### BACKGROUND OF THE INVENTION

1. Technical Field

The present invention pertains to wireless transmission of data and voice via, for example, the third generation cellular communication networks. In particular, the present invention relates to adjusting the power level of a transmitter in a user equipment device, such as a cellular handset.

2. Discussion of related art

The signal power output level of a user equipment (UE) device (e.g. a cellular handset) is controlled by commands received from a service access point (SAP) such as e.g. a base transceiver station or a so-called Node B. Efficient means of power control methods are required to minimize radio interference between UE devices that share common frequency bands. Ideally, in the uplink direction, all signals should arrive at the receiver of a SAP with the same signal intensity. Therefore, the output power level of a UE device is constantly adjusted. The devices far from the SAP should transmit with considerably higher power than the devices close to the SAP.

There are two basic types of power control: open-loop and closed-loop. In open-loop power control, the UE device set its output power to a value it chooses; it is used for setting initial uplink and downlink transmission power when a UE device is accessing the network. In closed-loop power control, the SAP measures the quality of the transmission from a UE device, and then sends power control commands to UE device, adjusting the transmission power used by the UE device, and so adjusting the quality of the transmission from the UE device.

In the third generation (3G) cellular system UMTS (Universal Mobile Telecommunication System) including a so-called UTRAN (UMTS Terrestrial Radio Access Network) in turn including a SAP for communicating with a UE device, the uplink closed-loop power control is further comprised by an inner loop power control (ILPC) and an outer loop power control (OLPC). In the former, the UE transmitter adjusts its output power in accordance with one or more transmit power control commands received from the SAP in order to maintain the uplink Signal-to-Interference Ratio (SIR) at a given SIR target, with the uplink SIR as measured by the SAP. The UTRAN typically includes for each cell site one or more SAPs all under the control of a Radio Network Controller (RNC), which in turn is controlled by the so-called core network (that ultimately connects to the Public Switched Telephone System), and in OLPC, the RNC adjusts the SIR target according to the uplink channel quality, which the RNC determines based on information provided by the SAP. Normally, the target SIR is updated for each UE device independently, according to a BLock Error Rate (BLER) value, a Bit Error Rate (BER) value, or some other indicator of channel quality.

It is known in the art that for the uplink (UL) dedicated channel (DCH), for OLPC in UTRAN-FDD (Frequency Division Duplex), the RNC updates the SIR target of each UL channel to the SAP. The SAP administers the OLPC, by comparing the SIR for the uplink signal with the SIR target and sending power control commands to the UE device in order to maintain the received SIR as close to the SIR target as possible. This OLPC mechanism relies on the RNC adjusting the SIR target based on received BLER statistics of the estimated connection quality. OLPC is a relatively slow control mechanism. FIG. 1 illustrates prior art uplink power control for a connection via the DCH between a UE device 10 and a SAP 11, where the RNC 12 controlling the SAP updates the SIR target for the uplink DCH according to a measured BLER or other indicator of quality of that channel. The SAP then runs the closed-loop power control and tries to maintain the SIR of the received signal as close to the SIR target as possible.

The so-called 3G Partnership Project (3GPP), which specifies UMTS, a current task is to specify enhanced DCH (E-DCH) support; the E-DCH is intended to provide improved UL packet access in UTRAN-FDD using dedicated transport channels, and for that, a more efficient OLPC mechanism is required. This is because, first, the data transfer rate of the E-DCH connection may vary frequently and in a large dynamic range and, second, the HARQ (Hybrid Automatic Repeat reQuest) operation of the E-DCH may reduce the residual BLER of the UL E-DCH (measured after the HARQ operation) very close to zero (because of the HARQ operation), as seen by the RNC. Therefore, the current OLPC in use with the existing DCH may not function efficiently for the E-DCH.

Since the OLPC can directly affect the overall system capacity, performance and coverage, a fast and efficient OLPC method for E-DCH is needed.

### DISCLOSURE OF INVENTION

Accordingly, the present invention provides a method, comprising: a step in which a service access point (SAP) of a radio access network (RAN) receives a target value for a block error rate (BLER) or other indicator of channel quality, and determines a new signal-to-interference ratio (SIR) target corresponding to the indicator of channel quality by comparing the target indicator of channel quality with a measured value for the indicator of channel quality; and a step in which the SAP uses the SIR target to provide power control commands to a user equipment device providing an uplink signal.

In accord with the first aspect of the invention, the SAP may use a plurality of SIR targets wherein each SIR target corresponds to a different data transfer rate, and the method further comprises a step in which the SAP detects the data transfer rate and then selects a SIR target from the plurality of SIR targets based on the detected data transfer rate. Further, the method may further comprise the step of tuning one or more of the plurality of SIR values based on comparing the target indicator of channel quality with the measured value for the indicator of channel quality.

Also in accord with the first aspect of the invention, the RAN may include a radio network controller (RNC) for connecting the SAP to a core network of a telecommunication system, and the RNC may provide the target indicator of channel quality.

In a second aspect of the invention, a computer program product is provided comprising a computer readable storage structure embodying computer program instructions thereon, by which a computer processor is enabled to perform the steps of a method according to the first aspect of the invention.

In a third aspect of the invention, a SAP of a RAN is provided, comprising: means for performing the steps of a method according to the first aspect of the invention.

In a fourth aspect of the invention, a system is provided, comprising: a user equipment (UE) device, for providing an unlink signal, and responsive to a power control command; and a RAN, for coupling the user equipment device to a core network, the RAN in turn including: a SAP, responsive to the uplink signal, for providing the power control command; and a RNC, for providing a BLER target or other indicator of channel quality; wherein the SAP comprises means for performing the steps of a method according to the first aspect of the invention.

The present invention provides faster, more accurate and flexible outer loop power control for the E-DCH connection, with its quickly changing data rate and with a HARQ operation potentially masking the received BLER from the RNC. Therefore, the present invention supports enhancing the efficiency of radio resource utilization, and thus system capacity, performance and coverage in serving E-DCH.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram illustrating a system in which uplink power control for the uplink DCH connecting a UE device with a SAP is performed according to the prior art.

FIG. 2 is a block diagram of initial setup and subsequent closed-loop power control according to the invention.

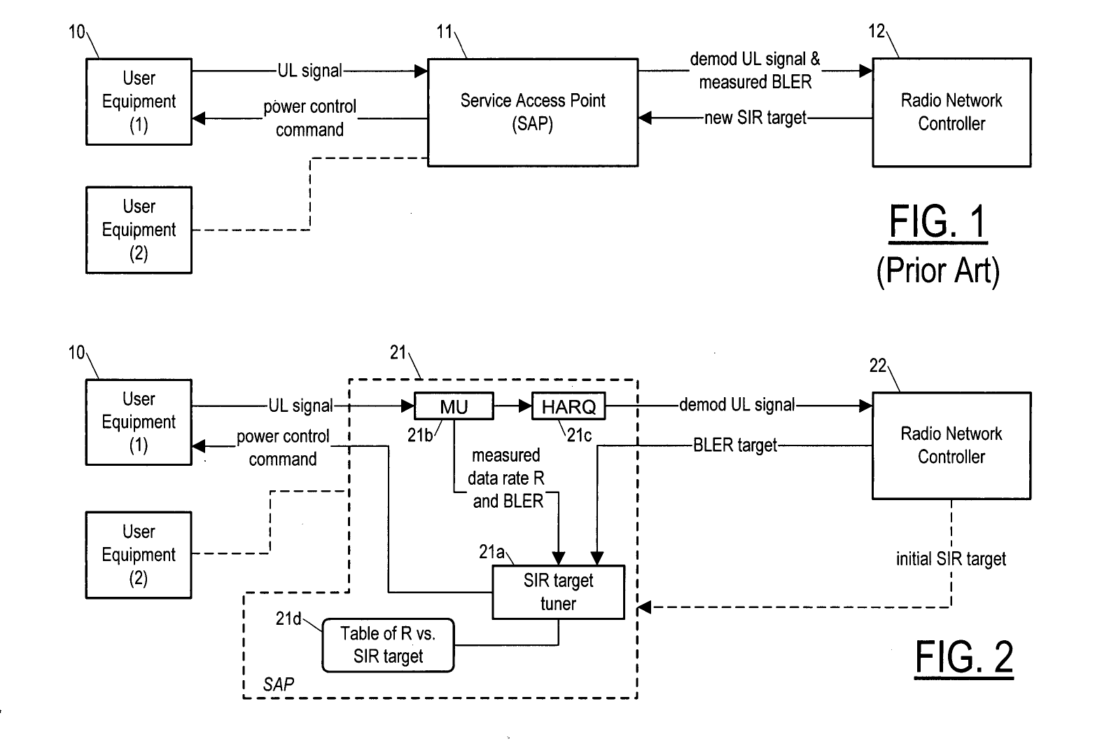

### BEST MODE FOR CARRYING OUT THE INVENTION

The invention is described below in case of a UE device communicating with a SAP via a E-DCH communication channel. However, the invention is in no way limited to use of E-DCH, but is instead of use for communication in any system including a UE device receiving power control commands from a SAP for wireless communication with the SAP.

Referring now to FIG. 2, according to the present invention, at the setup of a connection from a UE device 10 to a SAP 21 under the control of a RNC 22 of a UTRAN, the SAP receives from the UE device an uplink signal having a certain signal to interference ratio (SIR) and data transfer rate R. Now according to the invention, a SIR target tuner module 21a of the SAP receives from the RNC 22 a target value for the BLER (or for some other indicator of channel quality), and determines a new SIR target corresponding to the BLER target by comparing the BLER target with a measured uplink BLER value, and importantly, the measured uplink BLER is measured, by a measuring unit (MU) 21b, before any HARQ functionality 21c. If the BLER value is measured after any HARQ processing, the BLER value tends to be low even in relatively poor channel conditions, and so is only a spurious indicator of channel quality.

Thus, by comparing the measured and target BLER values, the SAP self-adjusts the SIR target it uses for OLPC, rather than receiving a new SIR target from the RNC, as is done according to conventional OLPC procedures. The adjustment made to the SIR target by the SAP according to the invention is based on the difference between the BLER target and the measured uplink BLER value; if the BLER value is less than the BLER target, the SIR target is increased. The SAP uses the new SIR target to provide power control commands to the UE device. (The measured BLER value—measured before any HARQ processing—takes into account both the channel conditions and the distance of the UE device from the SAP.)

In case of the E-DCH, the data rate can vary quickly, and the invention further provides that the SAP uses a possibly different SIR target for each of several data transfer rates, with each SIR target corresponding to the same BLER target. In such embodiments, the SAP determines a SIR target to use for power control based on a measured value of the uplink data transfer rate. FIG. 2 shows such an embodiment, where the SAP using a table 21d of rate R versus SIR target values. The SAP detects the rate R and, if the rate has changed, selects a from the table 21d a possibly new SIR target corresponding to the detected rate R.

In case of using a table providing SIR targets for different data transfer rates, when tuning the SIR target for the data rate in use by the UE device, the SAP may or may not also tune the SIR targets for the other data rates. Since the SIR target for the data rate in use is tuned because channel conditions have changed (deteriorated or improved), it is reasonable to change the SIR targets not only for the data rate in use, but also for the other data rates, since the channel conditions are to some extent independent of the data rate. However, it may be that for some data rates—especially lower data rates—the default or starting value of the SIR target should be used as the starting point for tuning, or the last tuned-to value.

The SAP could use different BLER target values at different times, or even for different data transfer rates. One or another of the BLER target values could be provided by other means than the RNC. For example, an operation and maintenance function (O&M) could provide one or another of the BLER targets to be used by the SAP.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
a step in which a service access point (SAP) of a radio access network (RAN) receives a target value for a block error rate (BLER) or other indicator of channel quality, and determines a new signal-to-interference ratio (SIR) target corresponding to the indicator of channel quality by comparing the target indicator of channel quality with a measured value for the indicator of channel quality; and
a step in which the SAP uses the SIR target to provide power control commands to a user equipment device providing an uplink signal.

2. A method as in claim 1, wherein the SAP uses a plurality of SIR targets wherein each SIR target corresponds to a different data transfer rate, and the method further comprises a step in which the SAP detects the data transfer rate and then selects a SIR target from the plurality of SIR targets based on the detected data transfer rate.

3. A method as in claim 2, further comprising the step of tuning one or more of the plurality of SIR values based on comparing the target indicator of channel quality with the measured value for the indicator of channel quality.

4. A method as in claim 11 wherein the RAN includes a radio network controller (RNC) for connecting the SAP to a core network of a telecommunication system, and the RNC provides the target indicator of channel quality.

5. A computer program product comprising a computer readable storage structure embodying computer program instructions thereon, by which a computer processor is enabled to perform the steps of a method including:
a step in which a service access point (SAP) of a radio access network (RAN) receives a target value for a block error rate (BLER) or other indicator of channel quality, and determines a new signal-to-interference ratio (SIR) target corresponding to the indicator of channel quality by comparing the target indicator of channel quality with a measured value for the indicator of channel quality; and
a step in which the SAP uses the SIR target to provide power control commands to a user equipment device providing an uplink signal.

6. A computer program product as in claim 5, further comprising computer program code for causing the SAP to perform a step in which the SAP detects the data transfer rate and then selects a SIR target from a plurality of SIR targets based on the detected data transfer rate.

7. A service access point (SAP) of a radio access network (RAN), comprising:
means by which the SAP receives a target value for a block error rate (BLER) or other indicator of channel quality, and determines a new signal-to-interference ratio (SIR) target corresponding to the indicator of channel quality by comparing the target indicator of channel quality with a measured value for the indicator of channel quality; and
means by which the SAP uses the SIR target to provide power control commands to a user equipment device providing an uplink signal.

8. A service access point as in claim 7, further comprising means by which the SAP detects the data transfer rate and then selects a SIR target from a plurality of SIR targets based on the detected data transfer rate.

9. A service access point as in claim 8, further comprising the means for tuning one or more of the plurality of SIR values based on comparing the target indicator of channel quality with the measured value for the indicator of channel quality.

10. A system, comprising:
a user equipment (UE) device, for providing an unlink signal, and responsive to a power control command; and
a radio access network (RAN), for coupling the user equipment device to a core network, the RAN including:
a service access point (SAP), responsive to the uplink signal, for providing the power control command; and
a radio network controller, for providing a block error rate (BLER) target or other indicator of channel quality;
wherein the SAP comprises:
means by which the SAP receives the target value for the BLER or other indicator of channel quality, and determines a signal-to-interference ratio (SIR) target corresponding to the target indicator of channel quality by comparing the target indicator of channel quality with a measured value for the indicator of channel quality; and
means by which the SAP obtains a measured SIR value for the uplink signal and uses the SIR target to provide power control commands to the UE device by comparing the measured SIR value to the SIR target.
